(19) United States
(12) Patent Application Publication
(10) Pub. No.: US 2005/0138419 A1
(43) Pub. Date: Jun. 23, 2005

(54) Automated role discovery

(76) Inventors: Pratik Gupta, Cary, NC (US); Govindaraj Sampathkumar, Durham, NC (US); David G. Kuehr-McLaren, Apex, NC (US); Vincent C. Williams, Aliso Viejo, CA (US); Sharon L. Cutcher, Austin, TX (US); Sumit Taank, Austin, TX (US); Brian A. Stube, Cambridge, MA (US); Hari Shankar, Cary, NC (US)

Correspondence Address: COATS & BENNETT, PLLC, P O BOX 5, RALEIGH, NC, 27602, US

(21) Appl. No.: 10/741,634

(22) Filed: Dec. 19, 2003

(51) Int. Cl. G06F 11/30; H04L 9/32

(52) U.S. Cl. 713/201; 713/166; 707/9

(57) ABSTRACT

An automated, bottom-up role discovery method for a role based control system includes automatically extracting identities and attributes from data sources and automatically clustering the identities based on the attributes to form recommended roles. The recommended roles may be modified by intervention of an administrator. Additionally, the recommended roles may be aggregated by defining the role definition as an attribute of each constituent identity, and re-clustering the identities to generate refined roles. The recommended, modified, and/or refined roles may then be utilized in a role based control system, such as a role based access control system. Periodically performing the role discovery process provides a means to audit a role based access control system.

### BACKGROUND OF THE INVENTION

The present invention relates generally to the field of software and in particular to a system and method of automated role discovery in role based control systems.

Role based control systems comprise an emerging and promising class of control systems that simplify and streamline the control task by elevating system control rules and decisions from the individual user or process level to a group level. In particular, the grouping of identities in a role based control system reflects the roles the corresponding individuals have as part of an organization that owns, controls, and/or manages the system.

A application for role based control systems is Role Based Access Control (RBAC). With respect to RBAC, access is defined as the ability to utilize a system, typically an Information Technology (IT) resource, such as a computer system. Examples of ways one may utilize a computer include executing programs; using communications resources; viewing, adding, changing, or deleting data; and the like. Access control is defined as the means by which the ability to utilize the system is explicitly enabled or restricted in some way. Access control typically comprises both physical and system-based controls. Computer-based access controls can prescribe not only which individuals or processes may have access to a specific system resource, but also the type of access that is permitted. These controls may be implemented in the computer system or in external devices.

With RBAC, access decisions are based on the roles that individual users have as part of an organization. Users take on assigned roles (such as engineer, manager, and human resources (HR) personnel). Access rights are grouped by role name, and the use of resources is restricted to individuals authorized to assume the associated role. For example, an HR employee may require full access to personnel records from which engineers should be restricted to preserve privacy, and engineers may require full access to technical design or product data from which HR employees should be restricted to preserve secrecy, while engineering managers require limited access to both types of data. Rather than set up (and maintain) each individual employee's access controls to the personnel and technical data, under RBAC, three roles may be defined: HR, engineer, and manager. All individuals in the organization who perform the associated role are grouped together, and access controls are assigned and maintained on a per-group basis.

The use of roles to control access can be an effective means for developing and enforcing enterprise-specific security policies, and for streamlining the security management process. User membership into roles can be revoked easily and new memberships established as job assignments dictate. New roles and their concomitant access privileges can be established when new operations are instituted, and old roles can be deleted as organizational functions change and evolve. This simplifies the administration and management of privileges; roles can be updated without updating the privileges for every user on an individual basis.

The current process of defining roles, often referred to as role engineering, is based on a manual analysis of how an organization operates, and attempts to map that organizational structure to the organization's IT infrastructure. This “top-down” process requires a substantial amount of time and resources, both for the analysis and implementation. The prospect of this daunting task is itself a significant disincentive for organizations using traditional access control methods to adopt RBAC.

### SUMMARY OF THE INVENTION

The present invention relates to a method of automatic role discovery. The method includes automatically extracting identities and associated attributes from one or more data sources, and automatically clustering the identities to form recommended roles, based on those attributes. The recommended roles are incorporated into a role based control system. Additionally, the recommended roles may optionally be reviewed by an administrator prior to the incorporation, and the user may optionally modify the recommended roles. These modifications cause an automatic re-clustering of the identities to form revised recommended roles, and the revised recommended roles are then incorporated into the role based control system.

In another aspect, the present invention relates to a method of auditing the access permissions of an information technology (IT) system via a role based access control system. The auditing method comprises automatically generating initial roles of individuals having access to the IT system, based on attributes associated with the individuals' identities. At a later time, subsequent roles of individuals then having access to the IT system are automatically generated based on attributes then associated with the identities. The initial roles and the subsequent roles are then compared to discover erroneous system accesses.

In yet another aspect, the present invention relates to a method of refining roles in a role based control system. The method comprises automatically generating initial roles of identities based on attributes associated with the identities. The initial roles are then aggregated to generate refined roles. One procedure for aggregating the initial roles is to define the role description of at least two of the initial roles as an attribute of each identity in each of the initial rolls, and automatically generating refined roles of identities based on attributes associated with the identities, including the newly defined attributes.

### BRIEF DESCRIPTION OF DRAWINGS

FIG. 1 is a functional block diagram of an automatic role discovery method according to one embodiment of the present invention.

FIG. 2 is a functional block diagram of an access audit method according to one embodiment of the present invention.

FIG. 3 is a flow diagram depicting a role definition algorithm according to one embodiment of the present invention.

### DETAILED DESCRIPTION OF THE INVENTION

In contrast to the “top-down” role definition process of the prior art, the present invention relates to a “bottom-up” role discovery process. In this process, existing roles in the organization are discovered by an analysis of the organization's IT infrastructure. In particular, access roles are discovered by an analysis of the existing IT system security structure. For example, user entitlement data—the systems, programs, resources, and data that a user has permission to access or modify—may be extracted for each user from the existing IT system. Users with the same or similar entitlements may then be intelligently clustered into groups that reflect their actual, existing roles within the organization. Not only does the bottom-up method of role discovery avoid the significant investment in time and effort required to define roles in a top-down process, it may also circumvent a disconnect between an organization's perceived roles and its actual roles. That is, the bottom-up method of role discovery is likely to be more accurate in that it reflects the actual, existing roles of users in the organization, as opposed to an individual's or committee's view of what such roles should look like.

Another significant advantage to the bottom-up role discovery process of the present invention is that it may be automated. That is, the process may be programmed in software and performed by one or more computers, taking advantage of powerful data mining tools and methodologies, and making the process feasible for very large data sets. As used herein, the term “automatically” means the associated action is performed in software on a computer, as opposed to being performed manually.

As discussed above, a well known application for role based control systems is Role Based Access Control (RBAC), a security application that restricts and manages users' access to an organization's resources. However, many other role based control systems are possible. For example, the operational parameters of a system may vary based on the role of a user, such as pilots having different roles experiencing correspondingly varying levels of performance and difficulty in a flight simulator, based on their role (which may, for example, model license level, experience, or type of aircraft for which the pilot is qualified). Additionally, an IT resource may not have a role based access control; however, the present invention may still be used to define the access controls for that resource. While the present invention is described herein as applied to a RBAC system, the invention is not so limited. In general, the role discovery process of the present invention may be advantageously applied to any role based control system, and the scope of the invention is determined by the claims, and is not limited to the exemplary embodiments and applications described herein.

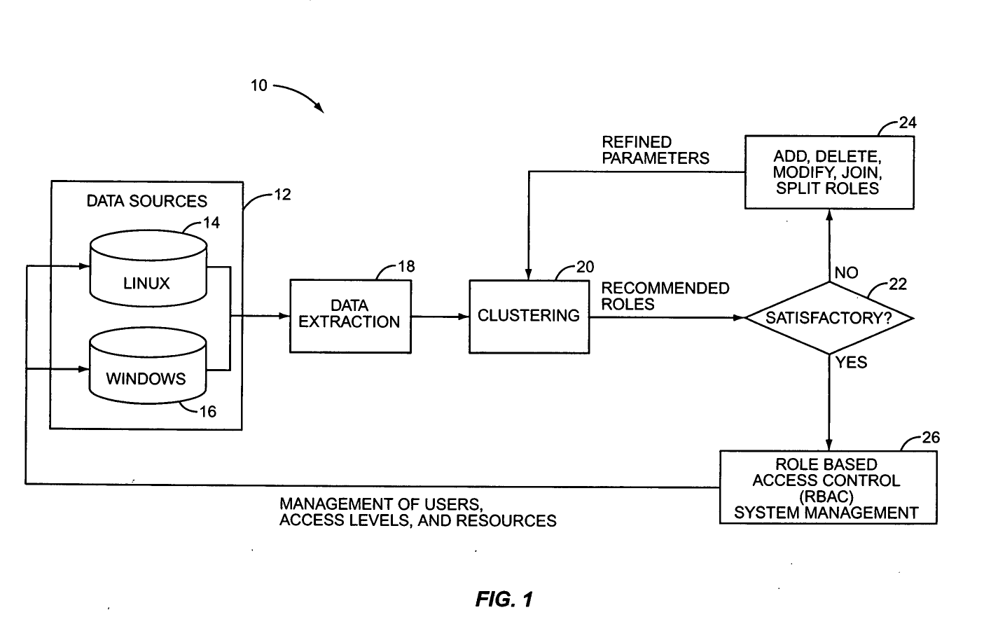

FIG. 1 depicts a bottom-up role discovery process according to one embodiment of the present invention, indicated generally by the numeral 10. The role discovery process begins by analyzing data sources 12. These may include, for example, IT resources such as computer systems, communications channels, and the like; HR systems such as payroll, personnel databases and management applications, and the like; applications such as computer aided design tools, software development and version control tools, web applications, and the like; databases such as DB2, Oracle, and the like; and operating system security and access parameters relevant to an operating system, such as groups in Unix, administrators in Windows NT, and the like. By way of example and without limitation, FIG. 1 depicts a Linux system 14 and Windows system 16 as representative data sources 12.

A wide range of data may be extracted from the data sources 12 by data extraction and transformation tools 18. The data extraction and transformation tools 18 may, in general, comprise a wide variety of data mining and analysis tools. The data extraction and transformation tools 18 may create lists of identities, and attributes associated with those identities. Attributes may include personal information such as employee title, location, date of hire, overtime/exempt status, and the like. A particular class of attributes of interest, defined herein as entitlements, are attributes associated with an identity that define or relate to the user's permissions, authorizations, and levels of access to organization resources. For example, entitlements may include the computer systems to which a user has access (i.e., an account or log in), the groups to which a user is assigned, file permissions, software or other resource licenses, communications system accesses, and the like. In general, the more comprehensive the data extraction process is, the more accurate the discovered roles will be.

In addition to data mining and extraction, the data extraction and transformation tools 18 also intelligently transform attributes, including entitlements, from disparate data sources to a common format. For example, the file permissions, groups, and similar entitlement attributes relevant to a Unix operating system do not compare directly to similar entitlements for a Macintosh, Windows, or other operating system. However, most operating systems implement similar distinctions among users regarding permissions and access. The data extraction and transformation tools 18 intelligently assess the attributes, including entitlements, associated with the identities and transform them into a common format, so that like entitlements relating to different data sources 12 may be compared. For example, a user with “administrator” status in a Windows NT system may be equated to a user having a “root” login on a Unix system. In general, a comprehensive set of heuristics and rules for transforming entitlements into a common format may be assembled and the transformations executed based on them, according to techniques well known in the art.

The extracted and transformed data is processed at block 20, where individuals are clustered into proposed or recommended groups or roles, based on the attributes associated with the individuals. In particular, roles pertinent to a Role Based Access Control system are generated by clustering identities according to entitlements associated with the identities. A variety of intelligent clustering or grouping procedures are known in the art, such as for example, through the use of various proximity algorithms. According to the present invention, the clustering 20 is a completely automated process, proceeding according to rules, heuristics, and algorithmic constraints selected or programmed into the clustering software.

Optionally, according to the present invention, the recommended roles generated by the clustering 20 may be reviewed by one or more users at step 22, such as via a Graphic User Interface (GUI). The user may inspect the recommended roles, and may specify changes to the recommended roles.

If desired, the user may add, delete, modify, join, or split the recommended roles at block 24. For example, the user may combine or aggregate roles to create more general-purpose roles. Alternatively, the user may restrict certain identities or classes of identities from a recommended role, perhaps generating a new role to contain the selected identities. Additionally, the user may alter the weighting of various attributes, causing different roles to be generated during the clustering step 20. In general, a wide variety of editing functions may be performed on the recommended roles.

As a result of modifications made to the recommended roles at step 24, the clustering at step 20 may be re-executed, generating a new set of recommended roles. This process may be repeated as necessary or desired. As such, the ability to inspect automatically generated recommended roles at step 22, and modify them at step 24, introduces an iterative element of control into the otherwise completely automated bottom-up role discovery process.

When the user, at step 22, is satisfied with the recommended roles, the user may approve the roles, at which point they are implemented into the desired system. For example, where the clustering at step 20 is based at least partially on entitlements associated with identities, the generated roles may be passed into a Role Based Access Control (RBAC) system management application 26. The system management application 26 then manages the organization's resources, including data sources 12, defining permissions, access levels, available resources, and the like based on individuals' roles rather than attempting to define such for each individual in the organization on an individual basis.

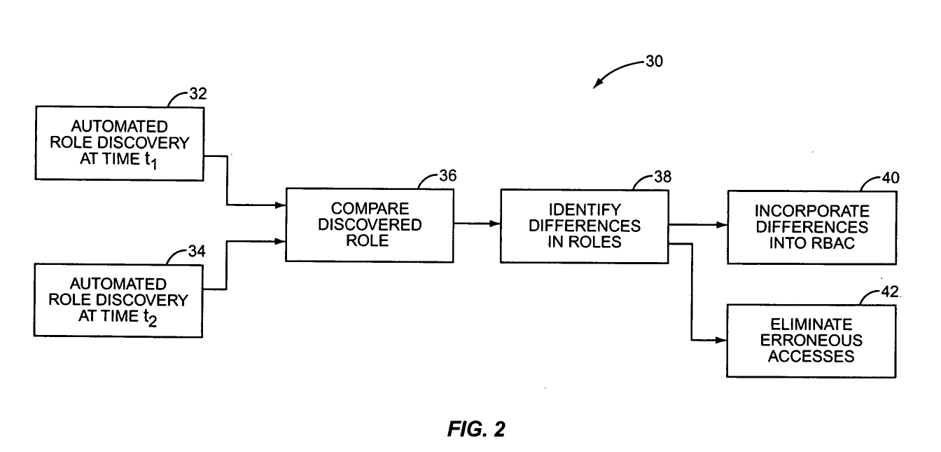

According to one aspect of the present invention, the automated role discovery process may be advantageously utilized to perform periodic system audits and updates. FIG. 2 depicts a flow diagram of the audit process, indicated generally by the number 30.

Initially, the automated role discovery process is performed at time T1, as shown in step 32. Subsequently, the automated role discovery process may be completely re-executed at time T2, as depicted in step 34, to generate a new set of roles based on the same set of systems and resources that generated the roles at time T1. Note that any editing of the automatically-generated roles at T1 should be noted or recorded by the role discovery application, and the same edits applied—manually or automatically—to the automatically-generated roles at time T2.

The discovered roles from times T1 and T2 are compared at step 36. Differences in the roles are detected and analyzed at step 38. Such differences may include roles generated at T1 that were not generated at T2, which may indicate that a role or function within the organization has terminated or been disbanded. Alternatively, new roles generated at T2 that were not generated at T1 may reflect a function or discipline added to the organization. Also, differences in the memberships of the various corresponding roles will indicate the movement of individuals—those leaving or joining the organization as well as an individual's changing functions within the organization.

The benign or acceptable detected differences may be incorporated into the RBAC system management at step 40, such as by adding the newly defined roles, deleting roles no longer justified, moving identities within roles, and the like.

An additional and significant benefit to the audit process 30 is the ability to discover, through differences in generated roles identified at step 38, erroneous or no longer justified accesses and permissions. For example, roles generated at T2 may lack certain identities that were part of the corresponding roles generated at T1. In this case, those individuals may retain access levels or permissions from their prior assignment to the T1 role. Identifying such identities may assist the system management program to identify and eliminate potential security threats and weaknesses.

The automated extraction of data and clustering of individuals into roles according to the present invention may initially generate a large number of relatively small recommended roles. For example, the automated clustering process may generate a recommended role comprising individuals that have a specific access level on a particular computer system who share offices in a particular building, when effective role based access control may require a coarser level of granularity, for example, all software engineers. In this case, according to one embodiment of the present invention, the bottom-up automated role discovery process may be implemented in multiple passes, with role definitions from one pass being utilized as entitlements for further clustering in subsequent pass(es). The process also finds utility in scaling to a large number of user attributes.

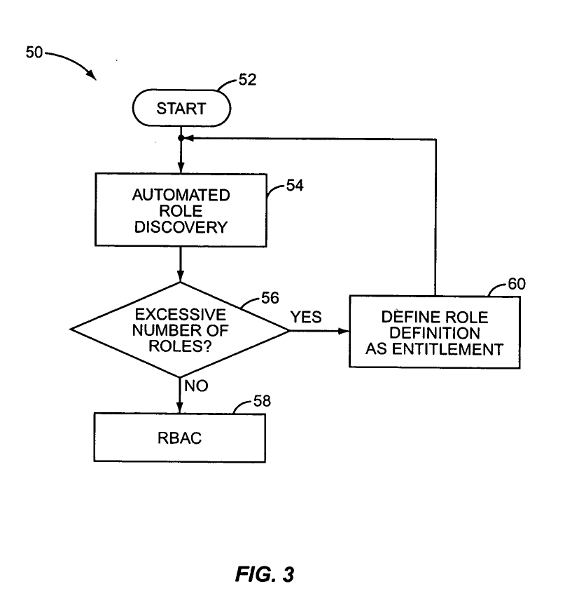

FIG. 3 depicts a flow chart describing a multi-pass role discovery process, indicated generally by the number 50. Starting at block 52, an initial automated role discovery process is initiated at step 54. This may generate a large number of recommended roles. The number of roles, and their properties, are inspected at step 56. If the roles are of the appropriate granularity, they may be incorporated into a role based control system, such as the role based access control system depicted at step 58.

Alternatively, if more generic or higher-level roles are desired, such as for example if the number of roles inspected at step 56 is excessive, then at step 50, the role definition may be defined as an entitlement and the entitlement added to the list of attributes of each identity within the role. The automated role discovery process is then re-executed at step 54, with the identities having the role memberships as the attributes. This process may be repeated as necessary or desired, until the roles have aggregated to the desired size and scope.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

1. A method of automatic role discovery, comprising:
automatically extracting identities and associated attributes from one or more data sources;
automatically clustering said identities to form recommended roles, based on said attributes; and
incorporating said recommended roles into a role based control system.

2. The method of claim 1 further comprising:
optionally reviewing said recommended roles by an administrator prior to said incorporation; and
optionally modifying said recommended roles by the administrator, said modifications causing an automatic re-clustering of said identities to form revised recommended roles; and
wherein incorporating said recommend roles into a role based control system comprises incorporating said revised recommended roles into said role based control system.

3. The method of claim 2 wherein modifying said recommended roles by the administrator comprises weighting said attributes.

4. The method of claim 2 wherein modifying said recommended roles by the administrator comprises altering which of said attributes are considered in said re-clustering.

5. The method of claim 1 further comprising transforming said attributes extracted from said data sources to a common format prior to said clustering.

6. The method of claim 1 wherein said attributes include entitlements, and wherein said clustering is based on said entitlements.

7. The method of claim 6 wherein said entitlements comprise the associated identity's access to resources.

8. The method of claim 1 wherein said role based control system is a role based access control system.

9. The method of claim 1 wherein automatically extracting identities and associated attributes from one or more data sources comprises, for each said data source, automatically forming a list of all identities contained in said data source and, for each said identity, all attributes contained in said data source that are associated with that identity.

10. The method of claim 1 wherein automatically clustering said identities to form recommended roles based on said attributes comprises grouping said identities according to the proximity of disparate identities' attributes.

11. The method of claim 10 wherein said attributes are entitlements, and wherein identities within each said recommended role have a similar level of access to resources.

12. A method of auditing the access permissions of an information technology (IT) system via a role based access control system, comprising:
automatically generating initial roles of identities having access to said IT system, based on attributes associated with said identities;
later, automatically generating subsequent roles of identities then having access to said IT system, based on attributes then associated with said identities; and
comparing said initial roles and said subsequent roles to discover erroneous system accesses.

13. The method of claim 12 wherein automatically generating both said initial roles and said subsequent roles comprises:
automatically extracting identities and associated attributes from one or more data sources;
automatically clustering said identities to form recommended roles, based on said attributes; and
incorporating said recommended roles into a role based control system.

14. The method of claim 13 wherein automatically generating both said initial roles and said subsequent roles further comprises:
optionally reviewing said recommended roles by an administrator prior to said incorporation; and
optionally modifying said recommended roles by the administrator, said modifications causing an automatic re-clustering of said identities to form revised recommended roles; and
wherein incorporating said recommend roles into a role based control system comprises incorporating said revised recommended roles into said role based access control system.

15. A method of refining roles in a role based control system, comprising:
automatically generating initial roles of identities based on attributes associated with said identities; and
aggregating said initial roles to generate refined roles.

16. The method of claim 15 wherein aggregating said initial roles to generate refined roles comprises:
defining the role description of at least two said initial roles as an attribute of each identity in each said at least two initial roles; and
automatically generating refined roles of identities based on attributes associated with said identities, including said newly defined attributes.

17. The method of claim 16 wherein automatically generating both said initial roles and said refined roles comprises:
automatically extracting identities and associated attributes from one or more data sources;
automatically clustering said identities to form recommended roles, based on said attributes; and
incorporating said recommended roles into said role based control system.

18. The method of claim 17 wherein automatically generating both said initial roles and said refined roles further comprises:
optionally reviewing said recommended roles by an administrator prior to said incorporation; and
optionally modifying said recommended roles by the administrator, said modifications causing an automatic re-clustering of said identities to form revised recommended roles; and
wherein incorporating said recommend roles into said role based control system comprises incorporating said revised recommended roles into said role based control system.

19. An automated method of role based access control, comprising:
automatically extracting identities and associated attributes from one or more data sources;
automatically clustering said identities to form initial recommended roles, based on said attributes;
optionally aggregating said initial recommended roles by defining the role description of at least two said recommended roles as an attribute of each identity in each said roles and automatically generating initial refined roles of identities based on attributes associated with said identities, including said newly defined attributes.
incorporating said initial recommended roles and optionally said initial refined roles into said role based control system;
later, automatically extracting identities and associated attributes from said data sources;
automatically clustering said identities to form subsequent recommended roles, based on said attributes;
optionally aggregating said subsequent recommended roles to form subsequent refined roles;
incorporating said subsequent recommended roles and optionally said subsequent refined roles into said role based control system; and
comparing said initial roles and said subsequent roles to discover erroneous system accesses.

20. A computer readable medium including one or more computer programs operative to cause a computer to generate roles suitable for a role based control system, the computer programs causing the computer to perform the steps of:
extracting identities and associated attributes from one or more data sources;
clustering said identities to form recommended roles, based on said attributes; and
incorporating said recommended roles into a role based control system.

21. The computer readable medium of claim 20, said computer programs causing the computer to further perform the steps of:
displaying said recommended roles prior to said incorporation; and
modifying said recommended roles based on input by an administrator, said modifications causing a re-clustering of said identities to form revised recommended roles; and
wherein incorporating said recommend roles into a role based control system comprises incorporating said revised recommended roles into said role based control system.

22. The computer readable medium of claim 20, said computer programs causing the computer to further perform the steps of
transforming said attributes extracted from said data sources to a common format prior to said clustering.
